(19) United States
(12) Patent Application Publication
(10) Pub. No.: US 2026/0356162 A1
(43) Pub. Date: Nov. 12, 2026

(54) VEHICLE HEAT PUMP SYSTEM AND CONTROL METHOD THEREOF

(71) Applicants: HYUNDAI MOTOR COMPANY, Seoul (KR); KIA CORPORATION, Seoul (KR)

(72) Inventors: Hao Fu, Yantai (CN); Rui Chen Zhang, Yantai (CN); Ding Yuan Fu, Yantai (CN); Jing Jing Shao, Yantai (CN); Yi Fan Cui, Yantai (CN); Jia Ning Jin, Yantai (CN); Tae Hun Jung, Hwaseong-si (KR); Xue Shan Tang, Yantai (CN)

(73) Assignees: HYUNDAI MOTOR COMPANY, Seoul (KR); KIA CORPORATION, Seoul (KR)

(21) Appl. No.: 19/385,858

(22) Filed: Nov. 11, 2025

(30) Foreign Application Priority Data
May 8, 2025 (CN) 202510593118.8

(51) Int. Cl. B60H 1/00

(52) U.S. Cl. CPC B60H 1/00899

(57) ABSTRACT

Operation of a vehicle heat pump system includes a first mode using a water-cooled condenser and a air-cooled condenser simultaneously and a second mode using only the air-cooled condenser. The system normally operates in the first mode. When a first switching condition is satisfied, the system switches from the first mode to the second mode by switching a three-way valve to prevent refrigerant from passing through the water-cooled condenser. When a second switching condition is satisfied, the system switches from the second mode to the first mode by switching the three-way valve. Therefore, the negative effects of the water-cooled condenser may be prevented by simply switching the three-way valve.

### CROSS REFERENCE TO RELATED APPLICATIONS

The present application claims priority to Chinese Patent Application No. 202510593118.8, filed May 8, 2025, the entire contents of which are incorporated herein for all purposes by this reference.

### BACKGROUND

### 1. Technical Field

The present disclosure relates to a vehicle heat pump system and a control method thereof.

### 2. Description of the Related Art

In the new energy vehicle field, heat pump systems are widely applied as a high-efficiency thermal management solution. In the cooling mode of a traditional heat pump system, the refrigerant moves through a fixed path of a compressor→an internal condenser→a water-cooled condenser (WCC)→an air-cooled condenser (ACC). In the above-mentioned series design, the refrigerant first exchanges heat with the cooling water in the WCC, and then exchanges heat secondarily in the ACC.

However, under certain operating conditions, because the temperature of the refrigerant introduced into the WCC is higher than the temperature of the cooling water in the WCC, the refrigerant absorbs heat from the cooling water rather than releasing heat. In such a case, the heat absorbed by the refrigerant needs to be released in the subsequent ACC, which results in additional loss of system energy. According to actual data, within 30 minutes of operation, the refrigerant absorbs heat in the WCC most of the time.

When the system cooling load is not large, the energy loss described above is more evident. Since the refrigerant is forced to pass through the WCC, the energy consumption of the system increases because the refrigerant inevitably passes through the above path even when heat exchange with the cooling water is not required.

The traditional system lacks a control strategy for the above problems, and energy is still wasted because the flow direction of the refrigerant cannot be adjusted as needed according to the actual operating conditions.

Moreover, the traditional system has room for improvement in the cooperative control between multiple subsystems, for example, air conditioning cooling, battery cooling, and motor cooling. It is also difficult to achieve the optimal temperature management effect. Some vehicle models may lack a complete temperature sensor configuration. Thus, the system cannot accurately judge the heat exchange status at the WCC location, making it impossible to adjust the control strategy in real time.

With regard to the above problems, attempts have been made for improvement in conventional technologies. For example, some systems add a bypass circuit to prevent energy loss, but such a measure leads to increased system complexity and cost. Some other systems use complex control algorithms to optimize the heat exchange effect, but the control effect is not ideal because the necessary temperature sensor data is insufficient.

The description provided above as related art of the present disclosure is just to help understand the background of the present disclosure and should not be construed as being included in the related art known by those of ordinary skill in the art.

### SUMMARY

In view of the above, a new control method is needed to prevent energy loss by intelligently judging the heat exchange effect of the WCC and by effectively controlling the flow direction of the refrigerant, and to improve the overall system efficiency by adapting to different temperature sensor configurations.

An objective of the present disclosure is to provide a vehicle heat pump system. The system includes a water-cooled condenser, an air-cooled condenser, an evaporator, and an internal condenser. The operation of the system includes a first mode using the water-cooled condenser and the air-cooled condenser simultaneously and a second mode using only the air-cooled condenser. The system basically or normally operates in the first mode. When a first switching condition is satisfied, the system switches from the first mode to the second mode by switching a three-way valve to prevent refrigerant from passing through the water-cooled condenser. When a second switching condition is satisfied, the system switches from the second mode to the first mode by switching the three-way valve.

In order to achieve the objectives of the present disclosure, a vehicle heat pump system is provided. The system includes: a water-cooled condenser, an air-cooled condenser, an evaporator, and an internal condenser. Operation of the system may include: a first mode using the water-cooled condenser and the air-cooled condenser simultaneously; and a second mode using only the air-cooled condenser. The system may basically or normally operate in the first mode. When a first switching condition is satisfied, the system may switch from the first mode to the second mode by switching a three-way valve to prevent refrigerant from passing through the water-cooled condenser. When a second switching condition is satisfied, the system may switch from the second mode to the first mode by switching the three-way valve.

In the vehicle heat pump system of the present disclosure, the system may further include a first temperature sensor configured to detect a refrigerant temperature at an outlet of the internal condenser, i.e., a first refrigerant temperature at an inlet of the water-cooled condenser. The system may also include a second temperature sensor configured to detect a second refrigerant temperature at an outlet of the water-cooled condenser. The system may further include a motor temperature sensor configured to detect an operating temperature of a system drive motor. The first switching condition may be satisfied based on a situation in which: i) a difference between the temperature detected by the second temperature sensor and the temperature detected by the first temperature sensor is greater than a preset first temperature threshold value; ii) the temperature detected by the motor temperature sensor is higher than the temperature detected by the first temperature sensor; and iii) each of (i) and (ii) is maintained for a preset first period of time. The second switching condition may be satisfied based on a situation in which a difference between the temperature detected by the first temperature sensor and the temperature detected by the motor temperature sensor is greater than a preset second temperature threshold value is maintained for a preset second period of time.

In the vehicle heat pump system of the present disclosure, the system may further include a motor temperature sensor configured to detect an operating temperature of a system drive motor. The first switching condition may be satisfied based on a situation in which a difference between the temperature detected by the motor temperature sensor and a simulated internal condenser outlet temperature, i.e., simulation temperature is greater than a sum of a preset third temperature threshold value and a simulation temperature compensation value is maintained for a preset third period of time. The second switching condition may be satisfied based on a situation in which a difference between the simulation temperature and the temperature detected by the motor temperature sensor is greater than a preset fifth temperature threshold value is maintained for a preset fourth period of time.

In the vehicle heat pump system of the present disclosure, a calculation formula for the simulation temperature may be as follows:

ST₄=K₀+K₁×T_{COMP}+K₂×T_{AMB}+K₃×N_{BLWR}+K₄×P_{TEMP}+K₅×V+K₆×P_{INTAKE}+K₇×T_{INCAR}.

In the equation: ST4 represents the simulation temperature; TCOMP represents a compressor outlet refrigerant temperature; TAMB represents an in-vehicle ambient temperature value used in the fully automatic temperature control (FATC) system; NBLWR represents a blower control value; PTEMP represents a temperature gate position percentage, which is 0 when coldest 1 when hottest; V represents a vehicle speed; PINTAKE represents an intake position percentage, which 0 for full ambient air intake 1 for full inside circulation intake; TINCAR represents an in-cabin temperature sensor value of the fully automatic temperature control system; and K0, K1, K2, K3, K4, K5, K6 and K7 are parameter values determined through real vehicle test data and data fitting.

In the vehicle heat pump system of the present disclosure, switching the three-way valve may have a delay time set.

In order to achieve the objectives of the present disclosure, a control method of a vehicle heat pump system is provided. The method includes switching from a default first mode that uses a water-cooled condenser and an air-cooled condenser simultaneously to a second mode that uses only the air-cooled condenser by switching a three-way valve when a first switching condition is satisfied. The method also includes switching from the second mode to the first mode by switching the three-way valve when a second switching condition is satisfied.

### BRIEF DESCRIPTION OF THE DRAWINGS

FIG. 1 is a view showing an example of the structure of a conventional heat pump system.

FIG. 2 shows temperature test results during operation of the conventional heat pump system.

FIGS. 3A-3C show a WCC+ACC mode, the ACC mode, and inlets and outlets of a three-way valve, respectively.

FIG. 4 is a view showing an example structure of a vehicle heat pump system of the present disclosure.

FIG. 5 is a flowchart of an operating mechanism of the vehicle heat pump system of the present disclosure.

### DETAILED DESCRIPTION

At the outset, a detailed description is given of a conventional vehicle heat pump system.

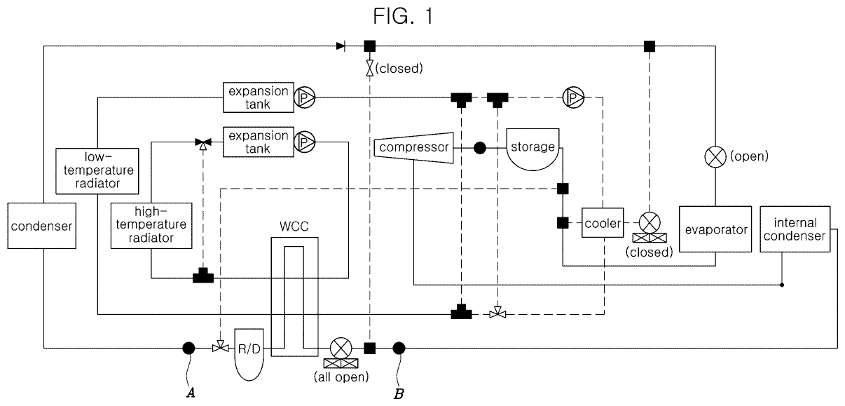

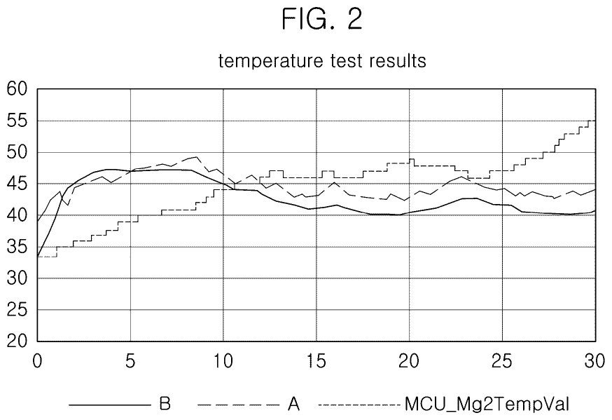

In conventional vehicle heat pump systems, especially those used for air conditioning cooling or battery cooling, there is a problem in that the refrigerant circulation path is fixed, resulting in energy waste. FIG. 1 is a view showing an example of the structure of a typical or conventional heat pump system. FIG. 2 shows temperature test results during the operation of the conventional heat pump system.

From the perspective of the system configuration, as shown in FIG. 1, the heat pump system mainly includes core components such as a compressor, an internal condenser, a water-cooled condenser (WCC), and an air-cooled condenser (ACC). In a cooling mode, the refrigerant travels through the compressor→the internal condenser→the water-cooled condenser (WCC)≥the air-cooled condenser (ACC). In the above structure, a series connection is utilized for the WCC and ACC. The refrigerant first exchanges heat with the cooling water in the WCC and then exchanges heat in the ACC secondarily.

The above case causes energy waste of the air conditioning system and a decrease in a coefficient of performance (COP) of the system. The heat absorbed by the refrigerant in the WCC ultimately needs to be released in the ACC, which increases the heat dissipation load of the ACC and lowers the overall cooling efficiency of the system. At the same time, since the heating effect of the WCC on the refrigerant is somewhat offset by the cooling effect of the internal condenser and the ACC, the compressor inevitably consumes more energy to achieve the same cooling effect.

When viewed from positions A and B shown in FIG. 1, the refrigerant temperature at position B is lower than the refrigerant temperature at position A. This was verified in the temperature test results shown in FIG. 2.

FIG. 2 shows the temperature change trend at each location of the system within a 30-minute test cycle. From the test data, it can be seen that, when the load of the cooling system is not large, i.e., relatively low, energy waste easily occurs in the conventional vehicle heat pump system. Specifically, within the 30-minute test cycle, most of the time, the refrigerant absorbs all the heat from the WCC, which contradicts the design purpose of the system.

To solve the above problems, the conventional technology has improved the system by adding two three-way valves near the WCC and removing a low-temperature radiator (LTR). Although the improvement enables adjustment of the flow direction of the refrigerant by controlling the three-way valves to a certain extent, it still does not fundamentally solve the problem of energy waste.

The main shortcomings of the conventional technology can be summarized as follows. First, the system structure is fixed and lacks flexibility. Thus, the flow path of the refrigerant cannot be self-adaptive adjusted according to the actual operating conditions. Second, under low-load operating conditions, energy waste easily occurs in which the refrigerant absorbs heat in the WCC and then releases heat in the ACC. Third, the system has limited ability to coordinate control for different cooling demands such as air conditioning cooling, battery cooling, and motor cooling. Fourth, the energy utilization efficiency is not high and, especially, the energy utilization efficiency is significantly low under some operating conditions.

The above problems have serious effects on the overall performance and energy efficiency of the heat pump system. Thus, the problems need to be effectively solved in new technical solutions. In particular, in the field of electric vehicles (EVs), since energy efficiency is directly related to the vehicle's driving distance, solving the above problems is a very important task.

When a component, device, unit, module, controller, sensor, element, or the like of the present disclosure is described as having a purpose or performing an operation, function, or the like, the component, device, unit, module, controller, sensor, or element should be considered herein as being “configured to” meet that purpose or to perform that operation or function. The present disclosure describes a heat pump system that may include a controller for operating or controlling aspects of the system. The controller, sensors, or other such components may separately embody or be included with a processor and a memory, such as a non-transitory computer readable media, as part of the controller or component.

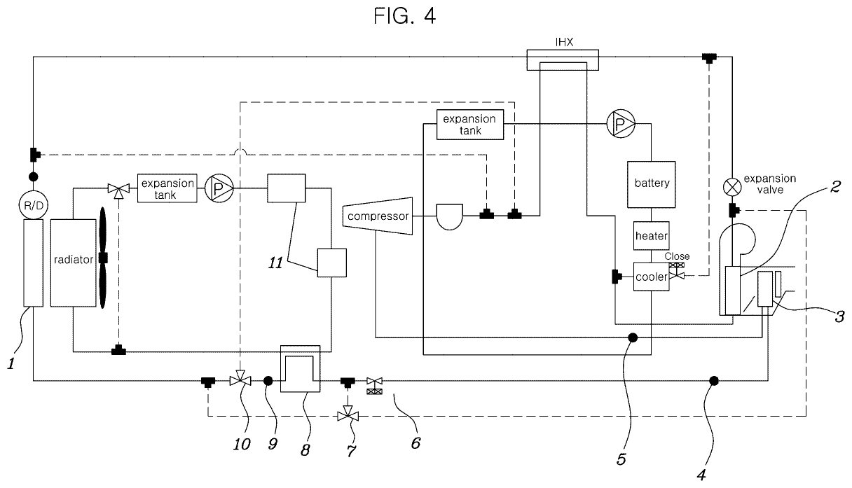

FIG. 4 is a view showing an example of the structure of a vehicle heat pump system of the present disclosure. As shown in FIG. 4, the system mainly includes an air-cooled condenser (ACC) 1, an evaporator 2, an internal condenser 3, temperature sensors 4, 5, and 9, an electronic expansion valve 6, three-way valves 7 and 10, a water-cooled condenser (WCC) 8, and a motor temperature sensor 11.

The ACC 1 uses ambient air to cool the high-temperature, high-pressure refrigerant from a vapor to a high-pressure liquid state by transferring heat from the refrigerant to the air. The evaporator 2 uses refrigerant to absorb heat from the surroundings, causing the refrigerant to undergo a phase change. The internal condenser 3 is used in the heat exchange process within the system. The temperature sensors 4, 5, and 9 are installed at different locations to monitor the operating temperature of the system in real time. The electronic expansion valve 6 controls the cooling amount of the system by adjusting the flow rate and pressure of the refrigerant. The three-way valve 7 controls the direction of flow of the refrigerant, allowing the system to switch between different operating modes. The WCC 8 cools the refrigerant through water cooling. The three-way valve 10 controls the flow path of the system, similar to the three-way valve 7. The motor temperature sensor 11 monitors the operating temperature of a system drive motor.

In the operation process of the vehicle heat pump system of the present disclosure, the refrigerant is compressed into a high-temperature and high-pressure gas in a compressor. The high-temperature gas is cooled sequentially through the ACC and the WCC. After being pressure-reduced through the expansion valve, the gas flows into the evaporator to absorb heat and evaporate. Finally, the gas flows back into the compressor to complete the cycle.

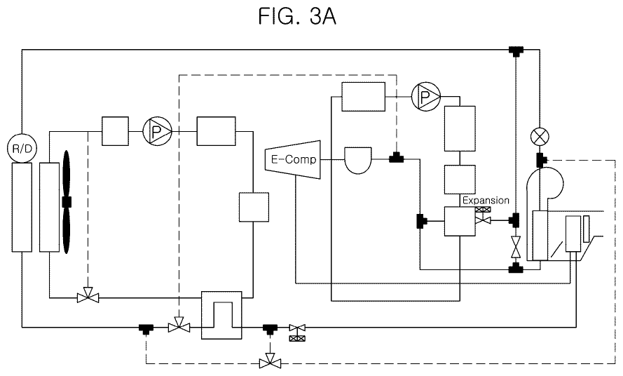

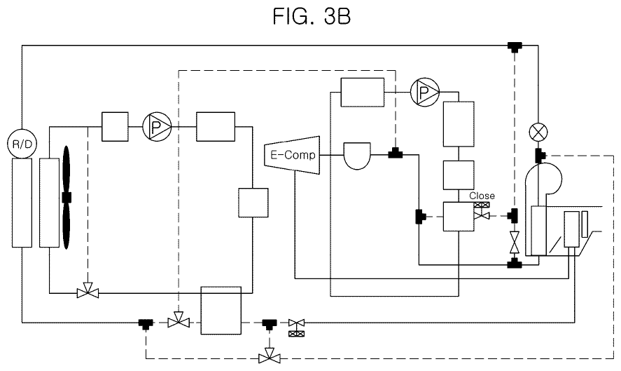

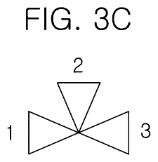

It should be noted that the present disclosure has two modes, namely, a WCC+ACC mode and an ACC only mode, and the two modes are illustrated in FIGS. 3A-3C. FIG. 3A shows the WCC+ACC mode and 3B shows the ACC mode. FIG. 3C shows inlets and outlets of the three-way valve and, as shown in the drawing, the numbers are indicated as an opening 1, an opening 2, and an opening 3.

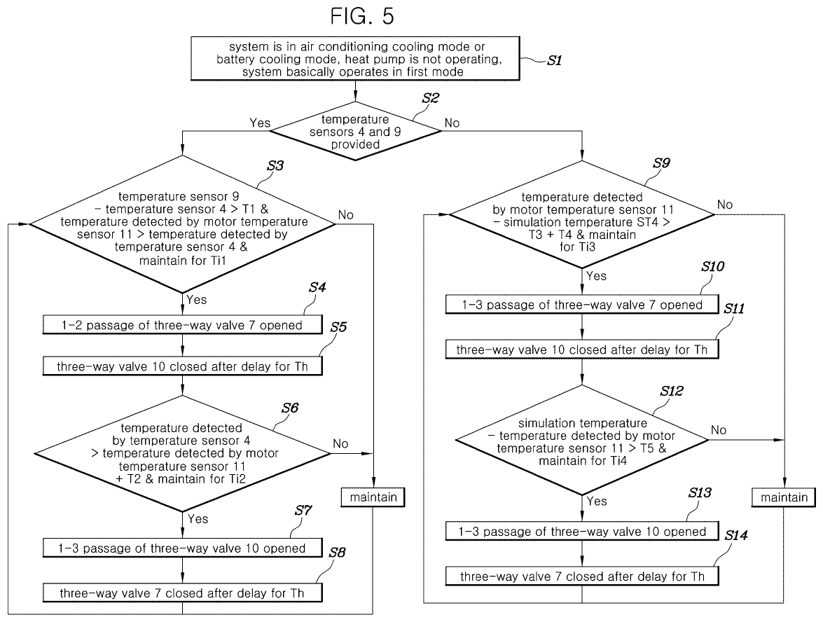

FIG. 5 is a flowchart of the operating mechanism of the vehicle heat pump system of the present disclosure.

At the initial step S1 of the flowchart, the system is in the air conditioning cooling mode or battery cooling mode, and a heat pump is not operating. In the above operating mode, the heat pump system provides a cooling function, and both the WCC and the ACC allow the refrigerant to release heat. In the default state, i.e., the basic or normal state, the system operates in the first mode (WCC+ACC mode). In this mode, the refrigerant is heat-exchanged sequentially through the WCC and the ACC.

Next, in step S2, it is determined whether the temperature sensor 4, i.e., a first sensor, and the temperature sensor 9, i.e., a second sensor, are installed in the system. This step is to determine which control strategy the system will use, because different control logic should be used depending on the different temperature sensor configurations.

In the case that the temperature sensors 4 and 9 are installed in the system (YES in step S2), the control logic of steps S3-S6 below is used.

In step S3, it is determined whether a first switching condition occurs based on certain temperature conditions being met for a predetermined period of time. The temperature conditions are i) whether the value obtained by subtracting the detection temperature, i.e., a first temperature of the temperature sensor 4 from the detection temperature, i.e., a second temperature of the temperature sensor 9 is higher than a first temperature threshold value T1 and ii) whether the temperature, i.e., the operating temperature of the motor temperature sensor 11 is higher than the detection or first temperature of the temperature sensor 4. If these two temperature conditions are met for a time period that exceeds the predetermined time, i.e., a first set time Ti1, then the first switching condition is satisfied.

The system evaluates the heat exchange effect of the WCC by judging or determining the relationship between the detection temperature of the temperature sensor 9 and the detection temperature of the temperature sensor 4. If the detection temperature of the temperature sensor 9 is higher than the detection temperature of the temperature sensor 4, the refrigerant absorbs heat from the cooling water when passing through the WCC. Such a situation is not beneficial to the cooling system because the situation contradicts the expected goal that the refrigerant should release heat in the WCC.

In addition, to prevent the system from switching the operating mode too frequently, the temperature threshold parameter T1 is set. When the detection temperature of the temperature sensor 9 is slightly higher than the detection temperature of the temperature sensor 4, it means that the heat absorbed by the refrigerant from the WCC is relatively small. At this time, in order to maintain the stability of the system operation, a control strategy to maintain the current operating mode is selected. Only when the temperature difference exceeds T1 is it judged or determined that there is significant heat absorption. Since the energy waste under this circumstance is not negligible, the system needs to or is configured to switch modes.

In addition, the system checks the value of the motor temperature sensor 11. The temperature sensor 11 measures the temperature of the cooling water before the cooling water flows into the WCC in the motor cooling circulation. To determine whether a mode change is necessary, the temperature, i.e., the operating temperature of the motor temperature sensor 11 should be higher than the first temperature of the temperature sensor 4. This is because, even if the cooling water is currently absorbing heat from the WCC, in the case that the temperature of the motor cooling water is lower than the detection temperature of the temperature sensor 4, as the system continues to operate, the temperature of the cooling water in the WCC continues to decrease. There is a possibility that the refrigerant will release heat in the WCC again. Thus, in such a case, in order to prevent unnecessary mode switching, the system maintains the current operating mode.

The temperature threshold value T1 may be adjusted according to the specific vehicle model and system characteristics. For example, in the vehicle heat pump system of this embodiment, T1 is set to 1 °C. When the motor temperature change in the system is relatively rapid, the T1 value may be appropriately increased to improve the stability of system operation.

To further secure the stability of system operation, the time parameter Ti1 is introduced. Only after the above temperature conditions (i.e., where the value obtained by subtracting the detection temperature of the temperature sensor 4 from the detection temperature of the temperature sensor 9 is higher than T1, and also where the operating temperature of the motor temperature sensor 11 is higher than the detection temperature of the temperature sensor 4) are continuously satisfied for the time Ti1, the mode is switched. For example, when the Ti1 is set to 5 seconds, the system performs mode switching only when the above temperature conditions are satisfied for 5 consecutive seconds.

In the case that the condition, i.e., the first switching condition of step S3 is satisfied (YES at step S3), a transition from mode 1 to mode 2 is performed. In step S4, a 1-2 passage of the three-way valve 7 is opened, and then, in step S5, after delaying for a time Th, the three-way valve 10 is closed. Opening the 1-2 passage of the three-way valve means connecting an outlet 1 and an outlet 2. In the case that the first switching condition of step S3 is not satisfied NO in step S3), the system maintains the current operating mode.

When performing a mode change, a special control strategy is used to ensure that the system transitions smoothly. To be specific, when the system changes from the first mode to the second mode, the 1-2 passage of the three-way valve 7 is first opened so that the outlet 1 and the outlet 2 are connected. In the above process, the system goes through an intermediate state, at which time the refrigerant may pass through the WCC or may pass through a bypass pipe. In the above case, both the three-way valve 7 and the three-way valve 10 are in the open state. After the preset delay time Th has elapsed, the three-way valve 10 is closed. The reason for using this gradual switching method is that, if two three-way valves are switched at the same time, refrigerant flow rate in the system may change abruptly, which may affect the stability of the system.

Next, after the system switches to the second mode, in step S6, it is determined whether a second switching condition occurs based on a certain temperature condition being met for a predetermined period of time. The temperature condition is whether the detection temperature of the temperature sensor 4 is higher than the sum of the operating temperature of the motor temperature sensor 11 and a second temperature threshold value T2. If this temperature condition is met for a time period that exceeds the predetermined period of time, i.e., a second set time Ti2, then the second switching condition is satisfied.

After the system switches to the second mode, the refrigerant only passes through the ACC and not through the WCC. Thus, the temperature value, i.e., the second temperature of the temperature sensor 9 is no longer of any use. In the above case, the system performs control using the motor cooling water temperature. Since the motor itself is equipped with a cooling water temperature sensor, the motor cooling water temperature may be regarded as the cooling water temperature at the WCC inlet. At this time, the second temperature threshold parameter T2 is introduced. When the difference between the detection or first temperature of the temperature sensor 4 and the maximum motor temperature is greater than T2 and the duration satisfying the above condition exceeds Ti2, the system switches the second mode to the first mode. For example, T2 may be set to 1.5 °C and Ti2 may be set to 5 seconds.

In the case that the condition, i.e., the second switching condition of step S6 is satisfied (YES in step S6), a transition from mode 2 to mode 1 is performed. In step S7, a 1-3 passage of the three-way valve 10 is opened, and then in step S8, after the delay of time Th, the three-way valve 7 is closed. In the case that the second switching condition of step S6 is not satisfied (NO in step S6), the system maintains the current operating mode.

When the system does not have the temperature sensors 4 and 9 (NO in step S2), the control logic of steps S9-S14 is performed.

In step S9, it is determined whether a first switching condition occurs based on a certain temperature condition being met for a predetermined period of time. The temperature condition is whether the value obtained by subtracting a simulation temperature compensation value, i.e., simulation temperature ST4 from the operating temperature of the motor temperature sensor 11 is greater than a third temperature threshold value T3+T4. If this temperature condition is met for a time period that exceeds the predetermined period of time, i.e., a third set time Ti3, then the first switching condition is satisfied.

In the case that the condition, i.e., a first switching condition of step S9 is satisfied (YES in step S9), a transition from mode 1 to mode 2 is performed. In step S10, the 1-2 passage of the three-way valve 7 is opened, and then in step S11, after the delay of time Th, the three-way valve 10 is closed. In the case that the first switching condition of step S9 is not satisfied (NO in step S9), the system maintains the current operating mode.

When the system does not have the temperature sensors 4 and 9, different control strategies need to be used. In this case, the system uses the motor temperature as a reference for the WCC inlet cooling water temperature. At the same time, one key parameter ST4 is introduced, which is the value of the internal condenser outlet temperature obtained through simulation calculation. The specific calculation method for ST4 is described below.

Under the above configuration, the judgment or determination of the mode switching of the system is mainly based on the following parameters.

First, a temperature parameter T3 is introduced to represent the temperature difference between the motor temperature (operating temperature obtained by motor temperature sensor 11) and ST4 (simulated internal condenser outlet temperature). The function of the parameter T3 is to ensure that the motor temperature is definitely higher than the internal condenser outlet temperature.

Next, since ST4 is a simulated temperature value, there is bound to be a certain deviation from the actual temperature, and thus a compensation parameter T4 is introduced. For example, when the simulated temperature value of ST4 is 30 °C, the actual temperature of the temperature sensor 4 may be 28 °C, which means that there is an error of 2 °C. Considering the above error, the system provides sufficient compensation margin by setting the T4 value to be larger than the expected error, for example, 3 °C.

When performing mode switching judgment, i.e., when determining whether to switch operating modes, the system detects the relationship between the temperature value, i.e., the operating temperature of the motor temperature sensor 11 and ST4. In the case that the value obtained by subtracting ST4 from the motor temperature is greater than T3+T4, it can be confirmed that the WCC inlet cooling water temperature is certainly greater than the WCC cooling water inlet temperature. In such a case, since the cooling water is likely to absorb heat in the WCC, it is necessary to consider switching the operating mode.

In order to prevent the system from switching the operating mode too frequently, a time parameter Ti3 is introduced. Only after the temperature condition is continuously satisfied for the time Ti3 (e.g., 5 seconds), the mode is switched from the first mode to the second mode.

Next, in step S12, it is determined whether a second switching condition occurs based on a certain temperature condition being met for a predetermined period of time. The temperature condition is whether the value obtained by subtracting the operating temperature of the motor temperature sensor 11 from the simulation temperature ST4 is greater than a fourth temperature threshold value T5+T4. If this temperature condition is met for a time period that exceeds the predetermined period of time, i.e., the predetermined period of time, i.e., a fourth set time Ti4, then the second switching condition is satisfied.

In the case that the condition, i.e., a second switching condition of step S12 is satisfied (YES in step S12), a transition from mode 2 to mode 1 is performed. In step S13, the 1-3 passage of the three-way valve 10 is opened, and then in step S14, after the delay of time Th, the three-way valve 7 is closed. In the case that the second switching condition of step S12 is not satisfied (NO in step S12), the system maintains the current operating mode.

When it is necessary to determine whether the system should switch from mode 2 back to mode 1, the same compensation value T4 is used. Also, a new temperature threshold parameter T5 is introduced. To be specific, when the value obtained by subtracting the operating temperature of the motor temperature sensor 11 from ST4 is greater than T5+T4, it means that the WCC inlet cooling water temperature is lower than the WCC cooling water inlet temperature. In the above case, since the refrigerant can normally release heat in the WCC, switching to the first mode is appropriate.

The parameter settings recommended by the system are T4 value 3 °C and T5 value 1.5 °C. Similarly, to ensure the stability of system operation, the time parameter Ti4 (recommended to be set to 5 seconds) is introduced. Only after the temperature condition is continuously satisfied for the time Ti4, the mode is switched from the second mode to the first mode.

According to the control strategy based on the above simulation temperature and compensation value, even under the situation where temperature sensors are not installed, the system is able to still realize the intelligent mode switching control to ensure the efficient operation of the system. By reasonably setting each temperature threshold parameter and time parameter, not only can the system instability caused by the error of the temperature simulation value be effectively prevented, but also the system can be ensured to respond to the change of the actual operating conditions in real time.

According to the above control method, the system may intelligently switch the operating mode according to the actual operating conditions, effectively preventing the negative cooling effect of WCC, and improving the energy efficiency of the system. At the same time, by setting reasonable temperature threshold values, time parameters, and gradual switching strategy, the stability of the system operation may be ensured.

Below, the calculation method for the simulation temperature ST4 is explained in detail.

For a system without a temperature sensor installed, the internal condenser outlet temperature ST4 needs to be obtained through simulation calculation. The simulation temperature ST4 is influenced by various factors, mainly including ambient temperature, blower control, temperature gate position, vehicle speed, air intake position, and in-cabin temperature sensor value. Through real vehicle testing, actual data on the above-mentioned influencing factors can be obtained under different operating conditions.

To be specific, the calculation formula for ST4 is as follows:

ST₄=K₀+K₁×T_{COMP}+K₂×T_{AMB}+K₃×N_{BLWR}+K₄×P_{TEMP}+K₅×V+K₆×P_{INTAKE}+K₇×T_{INCAR}

In the formula, the symbols have the following meanings:
TCOMP is the compressor outlet refrigerant temperature;
TAMB is the in-vehicle ambient temperature value used in the fully automatic temperature control (FATC) system;
NBLWR is the blower control value;
PTEMP is the temperature gate position percentage, which is 0 (0%) when coldest and which is 1 (100%) when hottest;
V is the vehicle speed;
PINTAKE is the intake position percentage, which is 0 (0%) when intake air is full ambient air and which is 1 (100%) when intake is full inside circulation, i.e., recirculated air; and
TINCAR is the in-cabin temperature sensor value of the fully automatic temperature control system.

The values of each coefficient K obtained or collected through actual vehicle testing and data fitting are as shown in the table below.

| | coefficient |
|---|---|
| K0 | 18.39445502 |
| K1 | 0.574012441 |
| K2 | 0.204211432 |
| K3 | −0.833637832 |
| K4 | −41.59085011 |
| K5 | −0.072141318 |
| K6 | 7.282075792 |
| K7 | −0.059221665 |

Taking the vehicle heat pump system of this embodiment as an example, the specific calculation formula is as follows.

ST4=18.39446+0.574012×TCOMP+0.204211×TAMB+(−0.83364)×NBLWR+(−41.5909)×PTEMP+(−0.07214)×V+7.2821×PINTAKE+(−0.05922)×TINCAR

The above coefficients are obtained by analyzing actual vehicle test data. During the test process, a thermocouple was used to measure the actual detection temperature value of the temperature sensor 4. At the same time, related parameter data is obtained through a controller area network (CAN) bus in a vehicle, and the above coefficients are obtained through data fitting.

As a result of comparing the temperature value measured by the temperature sensor 4 and the ST₄ value obtained through calculation, the distribution of the difference value between the two was as follows. That is to say, in more than 98% of cases, the error between the simulation value and the actual measurement value was less than 3 °C. According to the above statistical results, it is reasonable to set the compensation parameter T4 to 3 °C in the actual control strategy. The above compensation value may effectively cover the error that may occur in the simulation calculation, thereby ensuring the reliability of the control strategy.

The temperature simulation method based on the above-described multiple parameters has relatively high accuracy because the method considers the main factors affecting the internal condenser outlet temperature and is verified using the actual vehicle data. In addition, since the setting of compensation parameters is supported by reliable data, it can provide a reliable control basis for systems where relevant temperature sensors are not installed.

Since the simulation temperature ST4 obtained through the above method and the control strategy described in the above contents may realize accurate control of the operating mode of the system, the hardware cost of the system may be reduced while ensuring the accuracy of the control.

The control method of a vehicle heat pump system of the present disclosure has a remarkable energy saving effect and may effectively solve the energy waste problem existing in the conventional system under cooling mode.

When the conventional system is in the cooling mode, the temperature of the cooling water in the water-cooling circuit (WCC) may be higher than the temperature of the refrigerant. Thus, the energy exchange in the WCC may have a negative effect on the air conditioning system. At this time, the compressor should consume more energy to maintain the performance of the system, resulting in a waste of energy.

According to the control method of the present disclosure, judgment and control are carried out using the three-way valve employed in the system, values from the temperature sensors, and simulation values. When the cooling effect of the WCC comes out as negative, the three-way valve is controlled so that the refrigerant does not pass through the WCC. Due to the above method, the goal of energy saving may be achieved by preventing energy waste caused by the negative effect of the WCC.

By reasonably switching the operating mode of the system to switch between the first mode (WCC+ACC) and the second mode (ACC only), the flow direction of the refrigerant may be optimized according to the actual operating conditions, so as to further improve the energy utilization efficiency of the system and make the system more energy efficient and operate more effectively.

### INDUSTRIAL APPLICABILITY

The technical concepts of the present disclosure may prevent the negative effects of the WCC through a simple method of three-way valve switching, may improve the efficiency of a vehicle heat pump system with low cost and high reliability, and may be applied to conventional vehicles and other similar heat pump systems.

1. A vehicle heat pump system, the system comprising:
a water-cooled condenser;
an air-cooled condenser;
an evaporator; and
an internal condenser,
wherein an operation of the system includes a first mode using the water-cooled condenser and the air-cooled condenser simultaneously and includes a second mode using only the air-cooled condenser,
wherein the system normally operates in the first mode,
wherein, based on a first switching condition being satisfied, the system switches from the first mode to the second mode by switching a three-way valve to prevent refrigerant from passing through the water-cooled condenser, and
wherein, based on a second switching condition being satisfied, the system switches from the second mode to the first mode by switching the three-way valve.

2. The system of claim 1, further comprising:
a first temperature sensor configured to detect a first refrigerant temperature at an outlet of the internal condenser, which corresponds to an inlet of the water-cooled condenser;
a second temperature sensor configured to detect a second refrigerant temperature at an outlet of the water-cooled condenser; and
a motor temperature sensor configured to detect an operating temperature of a system drive motor,
wherein the first switching condition is satisfied based on a difference between the second temperature detected by the second temperature sensor and the first temperature detected by the first temperature sensor being greater than a preset first temperature threshold value based on the operating temperature detected by the motor temperature sensor being higher than the first temperature detected by the first temperature sensor, and based on each being maintained for a preset first period of time, and
wherein the second switching condition is satisfied based on a difference between the first temperature detected by the first temperature sensor and the operating temperature detected by the motor temperature sensor being greater than a preset second temperature threshold value and being maintained for a preset second period of time.

3. The system of claim 1, further comprising:
a motor temperature sensor configured to detect an operating temperature of a system drive motor,
wherein the first switching condition is satisfied based on a difference between an operating temperature detected by the motor temperature sensor and a simulated internal condenser outlet temperature being greater than a sum of a preset third temperature threshold value and a simulation temperature compensation value and being maintained for a preset third period of time, and
wherein the second switching condition is satisfied based on a difference between the simulation temperature compensation value and the operating temperature detected by the motor temperature sensor being greater than a preset fifth temperature threshold value and being maintained for a preset fourth period of time.

4. The system of claim 3, wherein:
a calculation formula for the simulation temperature is
ST₄=K₀+K₁×T_{COMP}+K₂×T_{AMB}+K₃×N_{BLWR}+K₄×P_{TEMP}+K₅×V+K₆×P_{INTAKE}+K₇×T_{INCAR};
ST4 represents the simulation temperature;
TCOMP represents a compressor outlet refrigerant temperature;
TAMB represents an in-vehicle ambient temperature value used in the fully automatic temperature control (FATC) system;
NBLWR represents a blower control value;
PTEMP represents a temperature gate position percentage, which is 0 when coldest, and 1 when hottest;
V represents a vehicle speed;
PINTAKE represents an intake position percentage, which is 0 based on full ambient air intake, and 1 based on full inside circulation intake;
TINCAR represents an in-cabin temperature sensor value of the fully automatic temperature control system; and
K0, K1, K2, K3, K4, K5, K6 and K7 are parameter values determined through real vehicle test data and data fitting.

5. The system of claim 1, wherein switching the three-way valve has a set delay time.

6. A method of controlling a vehicle heat pump system, the method comprising:
switching from a default first mode that simultaneously uses a water-cooled condenser and an air-cooled condenser to a second mode that uses only the air-cooled condenser by switching a three-way valve based on a first switching condition being satisfied; and
switching from the second mode to the first mode by switching the three-way valve based on a second switching condition being satisfied.

7. The method of claim 6, wherein the vehicle heat pump system comprises:
a first temperature sensor configured to detect a first refrigerant temperature at an outlet of an internal condenser, which corresponds to an inlet of the water-cooled condenser;
a second temperature sensor configured to detect a second refrigerant temperature at an outlet of the water-cooled condenser; and
a motor temperature sensor configured to detect an operating temperature of a system drive motor,
wherein the first switching condition is satisfied based on a difference between the second temperature detected by the second temperature sensor and the first temperature detected by the first temperature sensor being greater than a preset first temperature threshold value, based on the operating temperature detected by the motor temperature sensor being higher than the first temperature detected by the first temperature sensor, and based on each being maintained for a preset first period of time, and
wherein the second switching condition is satisfied based on a difference between the temperature detected by the first temperature sensor and the operating temperature detected by the motor temperature sensor being greater than a preset second temperature threshold value and being maintained for a preset second period of time.

8. The method of claim 6, wherein the vehicle heat pump system comprises:
a motor temperature sensor configured to detect an operating temperature of a system drive motor,
wherein the first switching condition is satisfied based on a difference between the operating temperature detected by the motor temperature sensor and a simulated internal condenser outlet temperature being greater than a sum of a preset third temperature threshold value and a simulation temperature compensation value and being maintained for a preset third period of time, and
wherein the second switching condition is satisfied based on a difference between the simulation temperature compensation value and the temperature detected by the motor temperature sensor being greater than a preset fifth temperature threshold value and being maintained for a preset fourth period of time.

9. The method of claim 8, wherein:
a calculation formula for the simulation temperature is
ST₄=K₀+K₁×T_{COMP}+K₂×T_{AMB}+K₃×N_{BLWR}+K₄×P_{TEMP}+K₅×V+K₆×P_{INTAKE}+K₇×T_{INCAR};
ST4 represents the simulation temperature;
TCOMP represents a compressor outlet refrigerant temperature;
TAMB represents an in-vehicle ambient temperature value used in the fully automatic temperature control (FATC) system;
NBLWR represents a blower control value;
PTEMP represents a temperature gate position percentage, which is 0 when coldest, and 1 when hottest;
V represents a vehicle speed;
PINTAKE represents an intake position percentage, which is 0 based on full ambient air intake, and 1 based on full inside circulation intake;
TINCAR represents an in-cabin temperature sensor value of the fully automatic temperature control system; and
K0, K1, K2, K3, K4, K5, K6 and K7 are parameter values determined through real vehicle test data and data fitting.

10. The method claim 6, wherein switching the three-way valve has a set delay time.
